(19) United States
(12) Patent Application Publication
(10) Pub. No.: US 2026/0095995 A1
(43) Pub. Date: Apr. 2, 2026

(54) DYNAMIC WHEELCHAIR PLATFORM LIGHTS

(71) Applicant: The Braun Corporation, Winamac, IN (US)

(72) Inventors: Justin M. Kline, Westfield, IN (US); Austin D. Metzger, Rensselaer, IN (US)

(73) Assignee: The Braun Corporation, Winamac, IN (US)

(21) Appl. No.: 19/332,851

(22) Filed: Sep. 18, 2025

Related U.S. Application Data
(60) Provisional application No. 63/699,938, filed on Sep. 27, 2024.

(51) Int. Cl. H05B 47/115; B60P 1/44; H05B 47/155; H05B 47/165

(52) U.S. Cl. CPC H05B 47/115; B60P 1/4428; H05B 47/155; H05B 47/165

(57) ABSTRACT

A dynamic lighting solution for a wheelchair lift is provided. The dynamic lighting solution may include a sensor to ascertain a position of a wheelchair lift platform. The sensor may be electrically coupled to a controller. The controller may be electrically coupled to a light source and configured to adjust a brightness or other lighting parameter of the light source based on the assessment of the position of the lift. The dynamic lighting solution may be configured to dim the light source when the lift platform is above the floor level of the vehicle. This solution prevents direct light from shining in the eye of an operator actuating the wheelchair lift.

### CROSS-REFERENCE TO RELATED APPLICATIONS

This application claims priority to U.S. Provisional Patent Application No. 63/699,938 filed on September 27, 2024, the contents of which are incorporated herein by reference. The contents of International Patent Application No. PCT/US25/46946, filed September 18, 2025, is also incorporated by reference.

### FIELD OF THE DISCLOSURE

The present disclosure relates generally to a passenger vehicle that has been modified to allow access by a physically limited passenger, and more particularly to a wheelchair access device with platform lighting and controls for automatically adjusting at least one lighting parameter, such as luminous flux (brightness/lumens), frequency (e.g., color), angle of illumination, pattern (e.g., focused beam or broader spread), and color, to reduce the chances of visual impairment for the operator.

### BACKGROUND

Vehicle manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by adding and/or removing certain parts or structures within a vehicle to accommodate the physically limited passenger. For example, in one configuration, a passenger van, bus, motorcoach, or different classes of motorhome, such as class A, is retrofitted with a lift assembly that enables a physically limited passenger to enter or to exit the vehicle. In some embodiments, the lift assembly is adapted for a physically limited passenger using a wheelchair or other mobility device. In another configuration, a vehicle can be equipped with a different type of vehicle access device, such as a ramp that allows a wheelchair rolling access to the vehicle.

Many of the vehicles in which wheelchair lifts are installed have a high floor such that the wheelchair lift is stowed above an operator standing adjacent to the vehicle. Many lifts have hand-operated controllers that require an operator to actuate the lift, and the controllers are often tethered by wires directly to the lift such that the operator cannot move too far away from the lift when operating.

Many standards such as NHTSA, ADA, FMVSS, and others govern the features that must be included in a wheelchair lift. One of the important standards to meet is adequate platform lighting for loading and unloading a passenger in dark conditions. The standard requires the lights to illuminate the platform to reach a minimum lumen. The applicable standard is FMVSS § 571.404 S4.1.5, copied below:

S4.1.5 Platform Lighting on public use lifts. Public-use lifts must be provided with a light or set of lights that provide at least 22 lm/m 2 or 22 Lux (2 lm/ft 2 or 2 foot-candles) of illumination on all portions of the surface of the platform when the platform is at the vehicle floor level. Additionally, a light or set of lights must provide at least 11 lm/m 2 or 11 Lux (1 lm/ft 2 or 1 foot-candle) of illumination on all portions of the surface of the platform and all portions of the surface of the passenger-unloading ramp at ground level. In preparation for taking illumination measurements, operate the vehicle engine by idling or driving the test vehicle, with the vehicle's HVAC system turned off, for a minimum of 20 minutes, after which the engine is turned off. Illumination measurements are then recorded no later than 10 minutes after the time the engine is turned off, with the vehicle in a location where there is no apparent ambient light, and with the sensing element of the measuring device within 50 mm (2 inches) of the platform surface being measured.

Since the lights are required to illuminate the platform, they often are angled downwards at the platform. This often results in the lights shining in the eyes of an operator standing adjacent to the lift when the platform is above the operator. Lights shining at an operator may cause visual impairment or cause the operator to look away from the lift while operating, which could cause a safety hazard. Similar problems may exist with other types of wheelchair access devices, such as a ramp that folds vertically upwards from the vehicle floor in a stow position.

### SUMMARY OF THE EMBODIMENTS

In one embodiment, a wheelchair lift is provided that may have lights configured to illuminate a platform of the lift. The wheelchair lift may be a dual parallel arm lift in which the platform of the wheelchair lift stows by rotating approximately 90 degrees to stow the platform substantially vertical. The lift platform may move from the stow position to the deploy position in two stages, the first may be an unfold operation which may move the platform to be substantially horizontal at the elevation of a floor of a vehicle that the lift is installed in. The second stage may be a vertical travel from the elevation of the vehicle floor level to the ground. The two stages ensures that a mobility passenger may be lifted to the floor level to facilitate easy entrance of the vehicle.

In an example of this embodiment, the wheelchair lift may include one or more lights. The one or more lights may be configured to illuminate the platform for visibility in dark conditions. The one or more lights may be mounted to one or more vertical supports configured to support the lift platform.

In another example of this embodiment, the platform may have raised side edges configured to prevent a mobility passenger from traversing the edge of the platform. One or more lights may be mounted to the raised side edges of the platform.

In a further example of this embodiment, the wheelchair lift may have one or more handrails. The one or more handrails may be mounted to the one or more vertical supports and configured to further prevent a mobility passenger from traversing the edge of the platform. One or more lights may be mounted on an underside of the one or more handrails.

Regardless of the mounting location of the one or more lights, the one or more lights may be pointed in a direction to substantially illuminate the platform. Typically, this results in the lights being mounted above the platform and aimed downwards towards the platform. The wheelchair lift may be actuated by an operator using a hand controller. To ensure safe deployment of the wheelchair lift, the operator may stand on the ground adjacent the vehicle. For high-floor vehicles, this may result in the lights shining downwards on the operator. To prevent the obstruction of an operator’s vision, the one or more lights may be dimmed when the platform is above the vehicle floor-level.

In one embodiment, a computing device may be provided. The computing device may be electrically coupled to the one or more lights and be configured to adjust the brightness of the one or more lights based on information received.

In one embodiment, the wheelchair lift may have a partial fold sensor configured to ascertain when the platform has reached a certain angle during operation. The partial fold sensor may be an existing lift feature integrated into a safety system for the wheelchair lift operations. The partial fold sensor may be used as a trigger to initiate the light adjustment. The computing device may be electrically coupled to the partial fold sensor and configured to receive when the partial fold sensor reaches the threshold angle. The threshold angle may be adjusted by a mouting orientation of the partial fold sensor. When the lift platform reaches the threshold angle, the computing device may then adjust the brightness of the one or more lights. During the wheelchair lift deployment operation, when the platform reaches a predetermined angle threshold the computing device may ascertain the threshold angle has been reached from the partial fold sensor and may brighten the one or more lights. During the wheelchair stow operation, the computing device may ascertain the threshold angle has been reached from the partial fold sensor and may dim the one or more lights.

In another embodiment, a position sensor may be added to the lift platform. The sensor may be configured to ascertain the elevation or level of the lift platform. The sensor may be electrically coupled to the computing device and configured to send the elevation or level signal to the computing device. The computing device may be programmed such that when the sensor reaches a predetermined elevation or angle threshold, the computing device may adjust the brightness of the one or more lights. During the wheelchair lift deployment operation, when the platform reaches a predetermined elevation or angle, the computing device may ascertain the threshold angle has been reached from the position sensor and may brighten the one or more lights. During the wheelchair stow operation, the computing device may ascertain the predetermined elevation or angle has been reached from the position sensor and may dim the one or more lights.

In another embodiment, the computing device may include a timing device configured to ascertain the length of input from a hand controller. The hand controller may have a switch for a fold and an unfold operation of the wheelchair lift for actuation during the deploy and stow processes respectively. The computing device may ascertain how long the operator is holding the fold or unfold switch. A delay may be programmed into the computing device as a threshold. The delay may be gathered from timing how long the wheelchair lift cycles from a stow to an unfolded configuration or vice versa. The computing device may be electrically coupled to the timing device and configured to receive a signal when the delay threshold is reached. The computing device may then be configured to adjust the brightness of the one or more lights.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of a prior art wheelchair lift that is provided with spotlights and is disposed in a deployed, floor-level position.

FIG. 2 is a perspective view of a prior art wheelchair lift that is provided with platform-mounted strip lighting and is disposed in a deployed, floor-level position.

FIG. 3 is a perspective view of a prior art wheelchair lift that is provided with handrail-mounted strip lights and is disposed in a deployed, floor-level position.

FIG. 4 is a perspective view of a wheelchair lift that incorporates handrail-mounted dynamic strip lights and is disposed in a stowed position.

FIG. 5 is a perspective view of the wheelchair lift of FIG. 4 in a partially deployed position.

FIG. 6 is a perspective view of the wheelchair lift of FIGS. 4-5 in a deployed, floor-level position.

FIG. 7 is a perspective view of the wheelchair lift of FIGS. 4-6 in a deployed, ground-level position.

FIG. 8 is an illustration of the dynamic lighting system.

FIG. 9 is a chart comparing the luminance flux of the dynamic strip lights in the lift positions of FIGS. 4-7.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

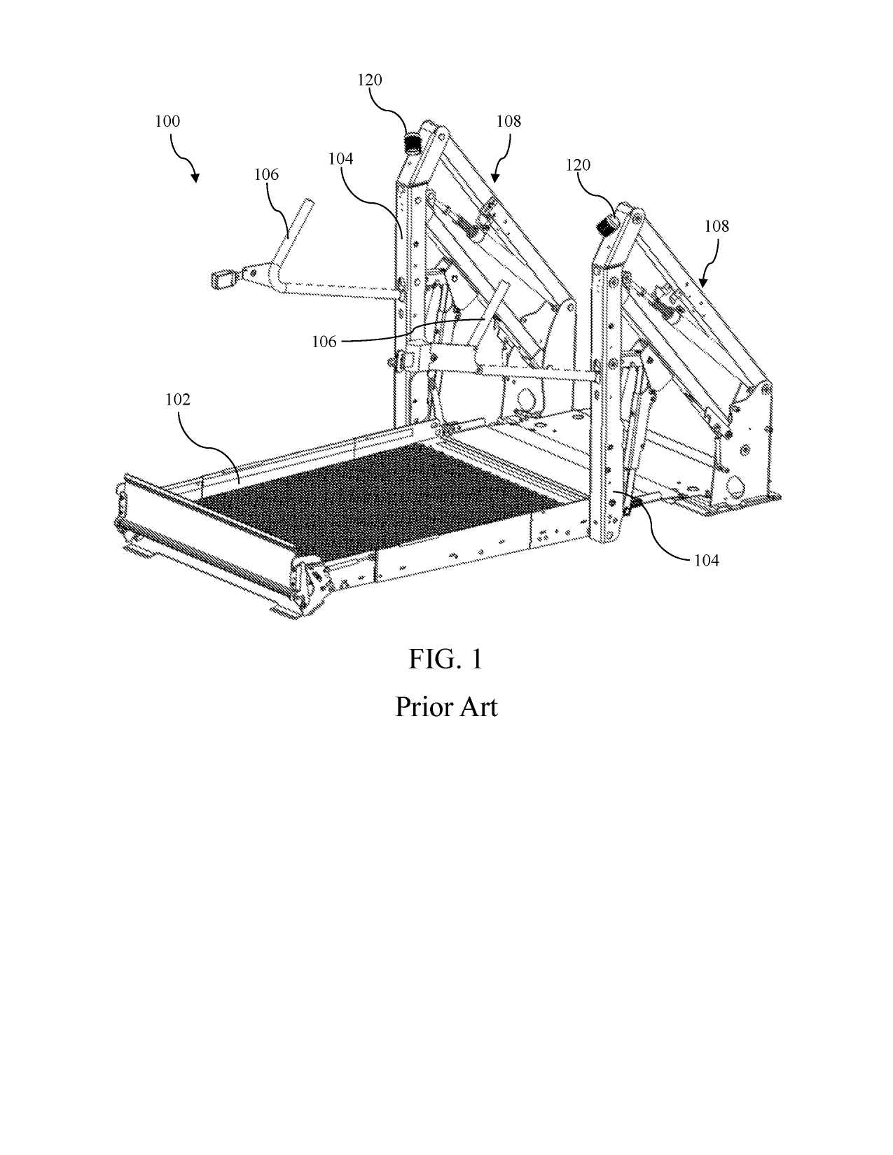

FIGS. 1-3 illustrate prior art wheelchair lifts 100 that substantially differ only in the form of light source. The wheelchair lift 100 may have a platform 102 configured to receive and support a wheelchaired passenger. The platform 102 may be coupled to the vehicle via at least one vertical support 104 and at least one parallel arm assembly 108 that are collectively configured move the platform 102 between a ground level and a vehicle floor level and permit a wheelchaired passenger vehicle ingress and egress. The wheelchair lift 100 may incorporate at least one handrail 106 for passenger safety. The wheelchair lift 100 shown in FIGS. 1-3 has two vertical supports 104, two parallel arm assemblies 108 (one coupled to each of the vertical supports), and two handrails 106 (one coupled to each of the vertical supports 104).

FIG. 1 illustrates one lighting solution for the wheelchair lift 100: one or more spotlights 120 may be coupled to the vertical supports 104 and angled at least partially downwards to illuminate the platform 102.

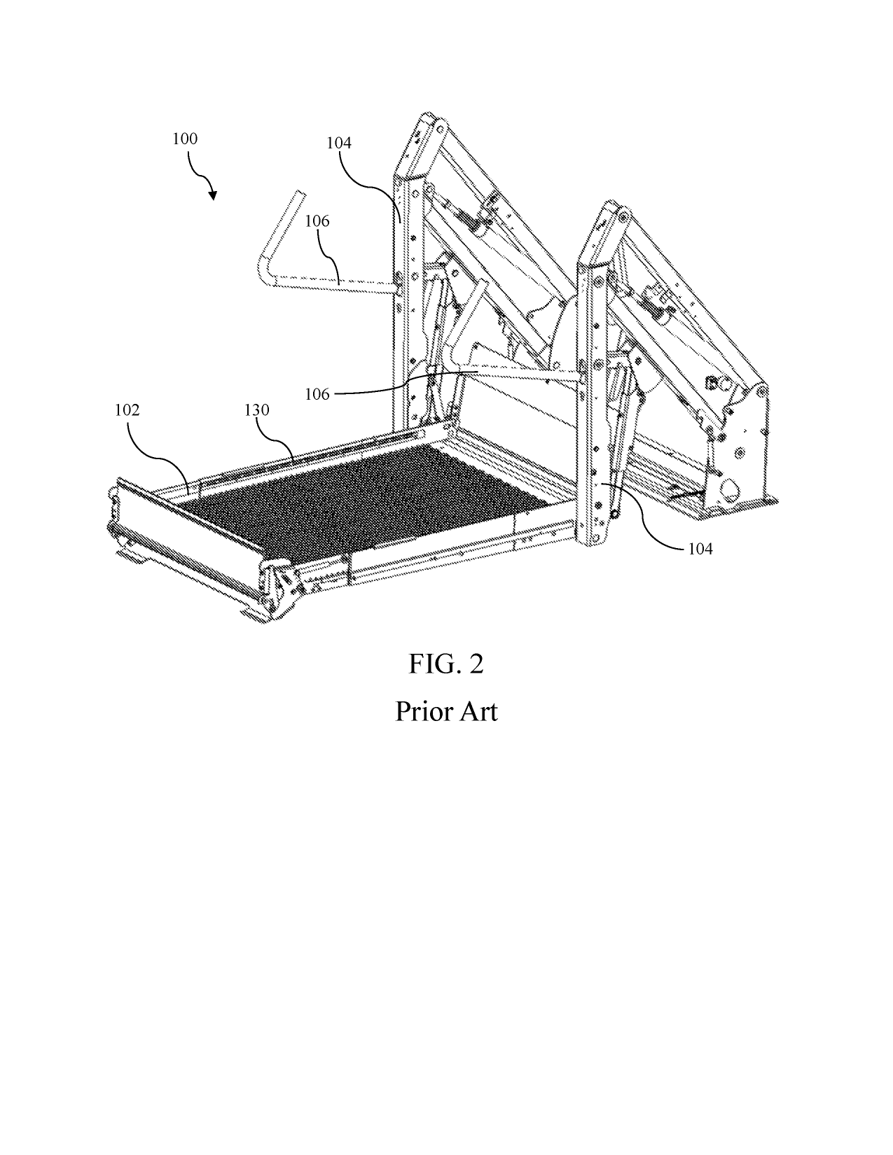

FIG. 2 illustrates a second lighting solution for a wheelchair lift 100: one or more light strips 130 may be coupled to the platform 102 and angled at least partially downwards to illuminate the platform 102. One light strip 130 may be on each side of the platform 102, although only one is visible in this perspective view.

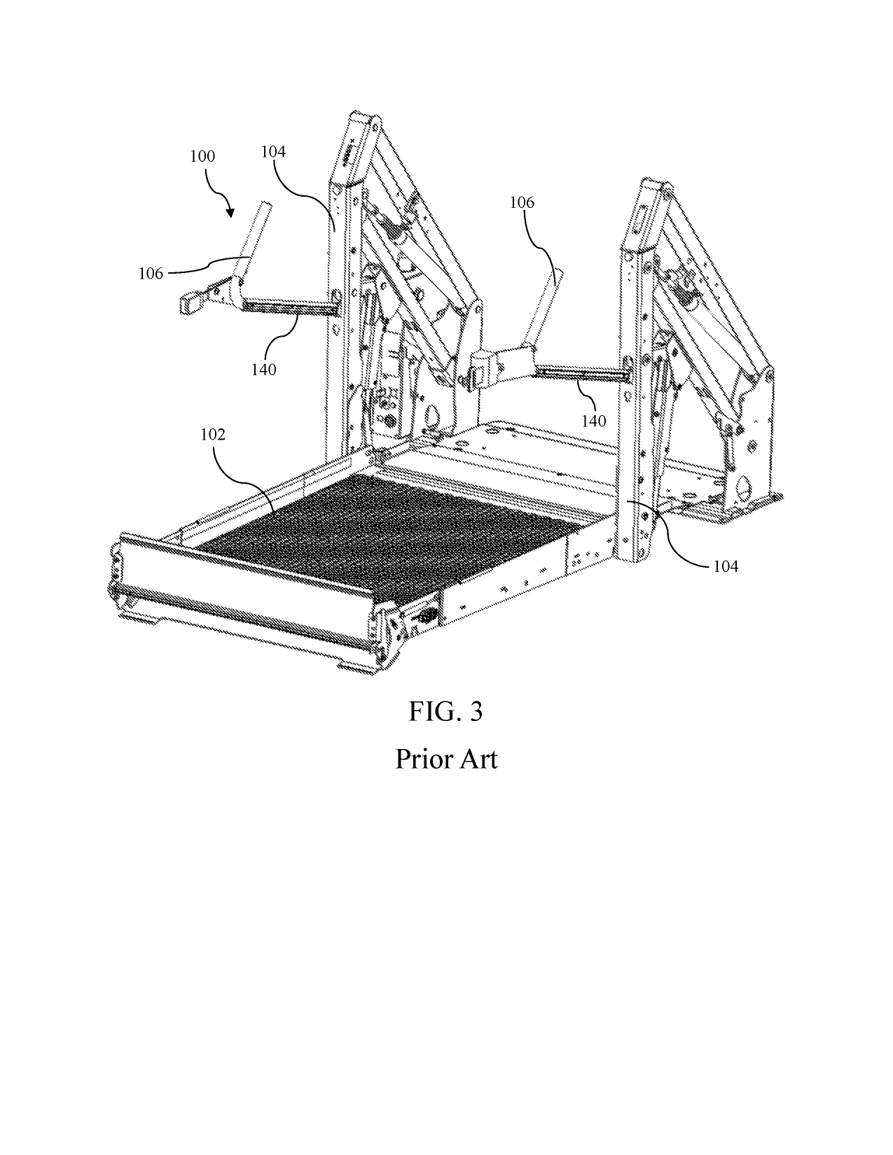

FIG. 3 illustrates a third lighting solution for a wheelchair lift 100: at least one light strip 140 may be coupled to the underside of at least one handrail 106. When the wheelchair lift 100 is in the deployed position, shown in FIG. 3, the light strip 140 is angled at least partially downwards to illuminate the platform 102. The wheelchair lift 100 shown in FIG. 3 has two light strips 140, one coupled to each handrail 106. Other types, configurations, and positions for the light source are possible and contemplated.

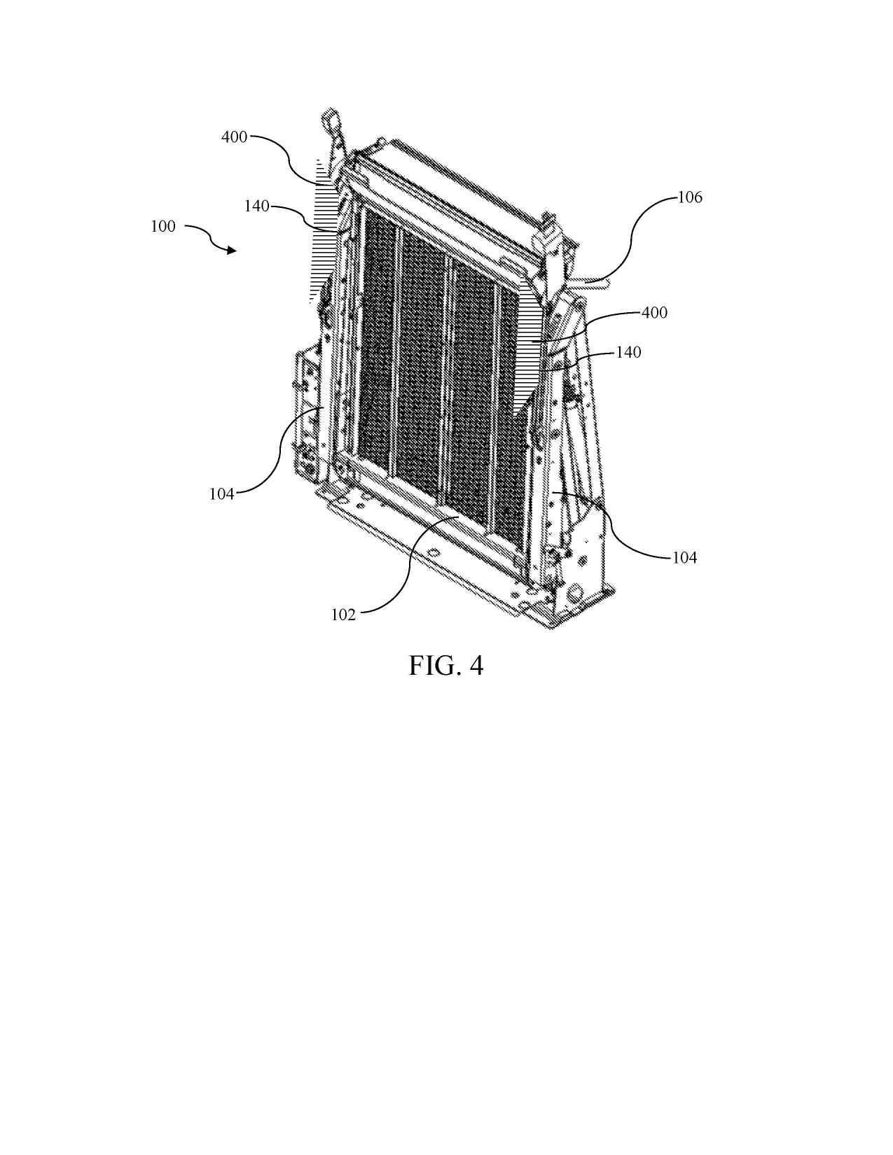

FIGS. 4-7 illustrate substantially the same wheelchair lift 100 shown in FIGS. 1-3, now upgraded with a dynamic lighting controller to reduce the chances of visual impairment for the lift operator. Similar to FIG. 3, the lighting solution in FIGS. 4-7 is the light strip 140 mounted to the underside of the handrail 106. However, other lighting solutions, including those shown in FIGS. 1-2, may be utilized with the dynamic lighting controller described hereinafter. The light source may be an LED, laser, lamp, fluorescent, incandescent, halogen, xenon, neon, argon, or other known light projection source.

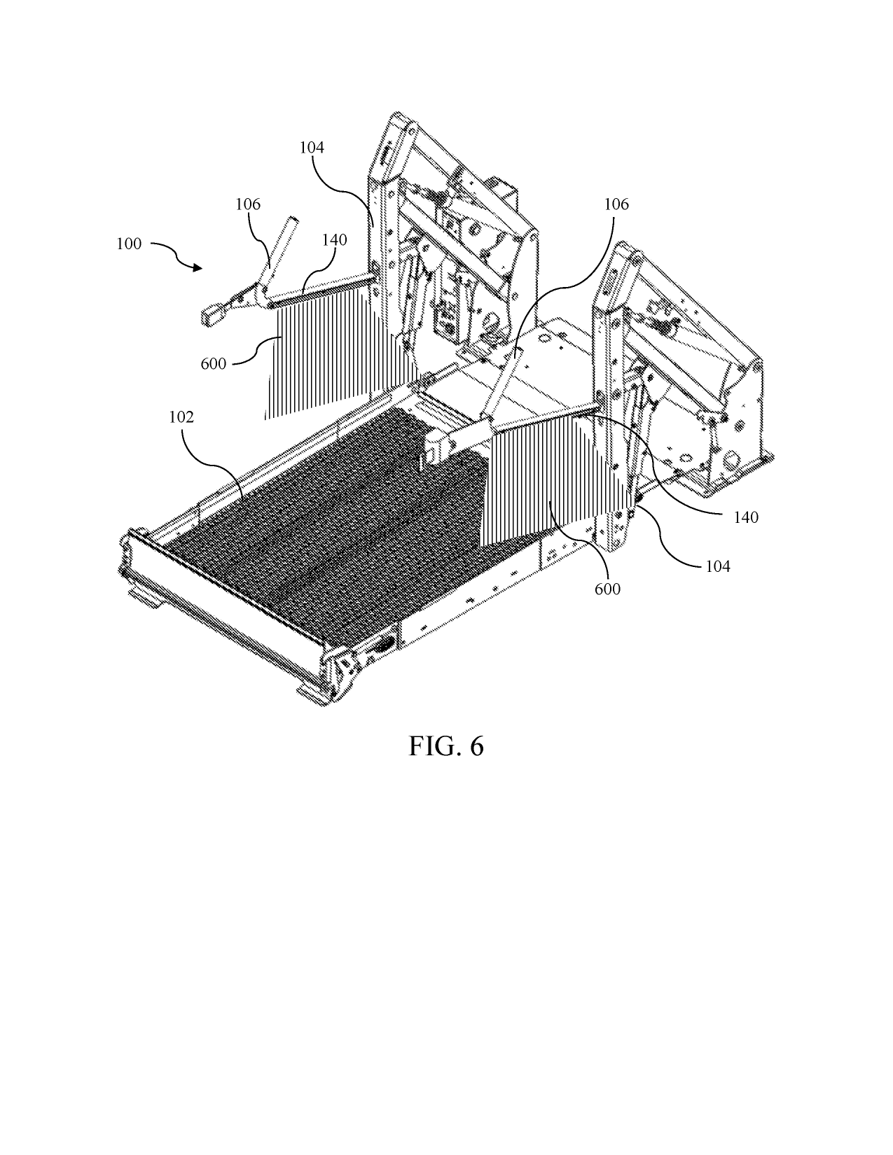

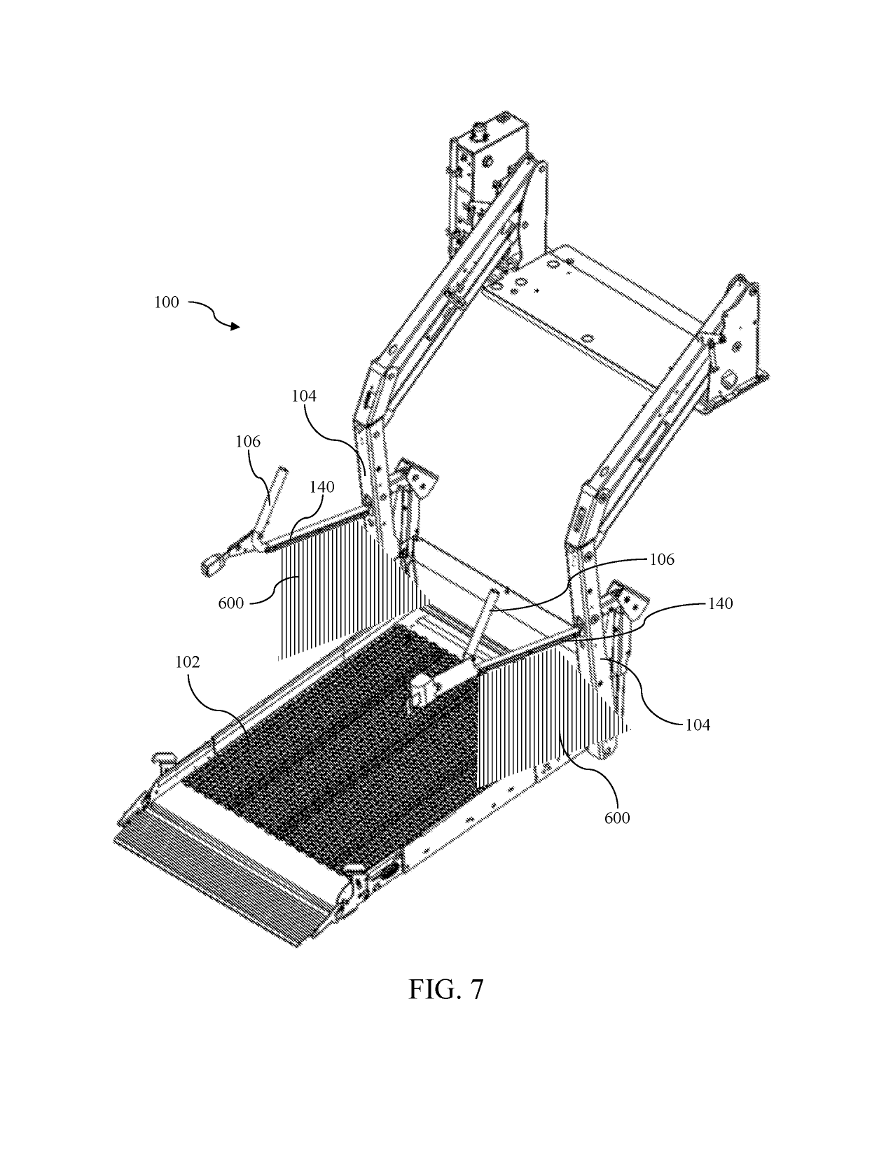

As can be seen in FIGS. 6 and 7, the handrail 106 of the wheelchair lift 100 has a horizontal configuration when the platform 102 is in a deployed position. To provide the wheelchair lift 100 with a compact package when the platform 102 is in the stowed position of FIG. 4, the handrail 106 folds upwardly with the platform 102 to a vertically-oriented position. Because the light strip 140 is mounted to the underside of the handrail 106, the emitted light will be projected outwardly away from the wheelchair lift 100 and toward the lift operator’s eyes when the handrail 106 is vertical, creating a risk of visual impairment for the lift operator. To reduce the chance or severity of such visual impairment, the aforementioned dynamic lighting control may be configured to change at least one lighting parameter shortly before, while, or shortly after the platform 102 is moved from the deployed position to the stowed position. For instance, the luminous flux may be reduced, the frequency can be reduced (making the light warmer), a diffuser can be applied to the light output, the light pattern or focus can be broadened, and/or the light direction can be adjusted away from the operator. Similarly, at least one lighting parameter may be adjusted shortly before, while, or shortly after the platform 102 is moved from the stowed position to the deployed position to ensure adequate lighting is provided for the platform 102 in compliance with applicable standards. For instance, the luminous flux may be increased, the frequency can be increased (making the light colder), a diffuser can be removed from the light output, the light pattern or focus can be narrowed, and/or the light direction can be adjusted toward the platform 102.

In some embodiments, the dynamic lighting controller may be adaptive, in that it changes lighting parameters based on the operator’s position as detected by a perception sensor (e.g., camera sensor, a LiDAR sensor, a ToF sensor, a RADAR sensor, a EmDAR sensor, a SONAR sensor, a SODAR sensor, a GNSS sensor, an accelerometer sensor, a gyroscope sensor, an IMU sensor, an infrared sensor, a laser rangefinder sensor, an ultrasonic sensor, an infrasonic sensor, and a microphone). In one embodiment, when the wheelchair lift 100 is in the stowed position, the luminous flux can increase when the operator walks a predetermined distance away from the wheelchair lift 100 to increase the visibility of the vehicle and surrounding area. In another embodiment, a perception sensor can track the location of the operator (or the operator’s head or eyes), and change the direction of the projected light away from the operator. The wheelchair lifts 100 may be controlled by a hand controller activated by the operator. A sensor may be coupled to the hand controller to ascertain the position of the operator relative to the wheelchair lift 100. The sensor coupled to the hand controller may be a GPS, LTE, 5G, Wi-Fi, Bluetooth 5, or any other sensors configured to ascertain a location.

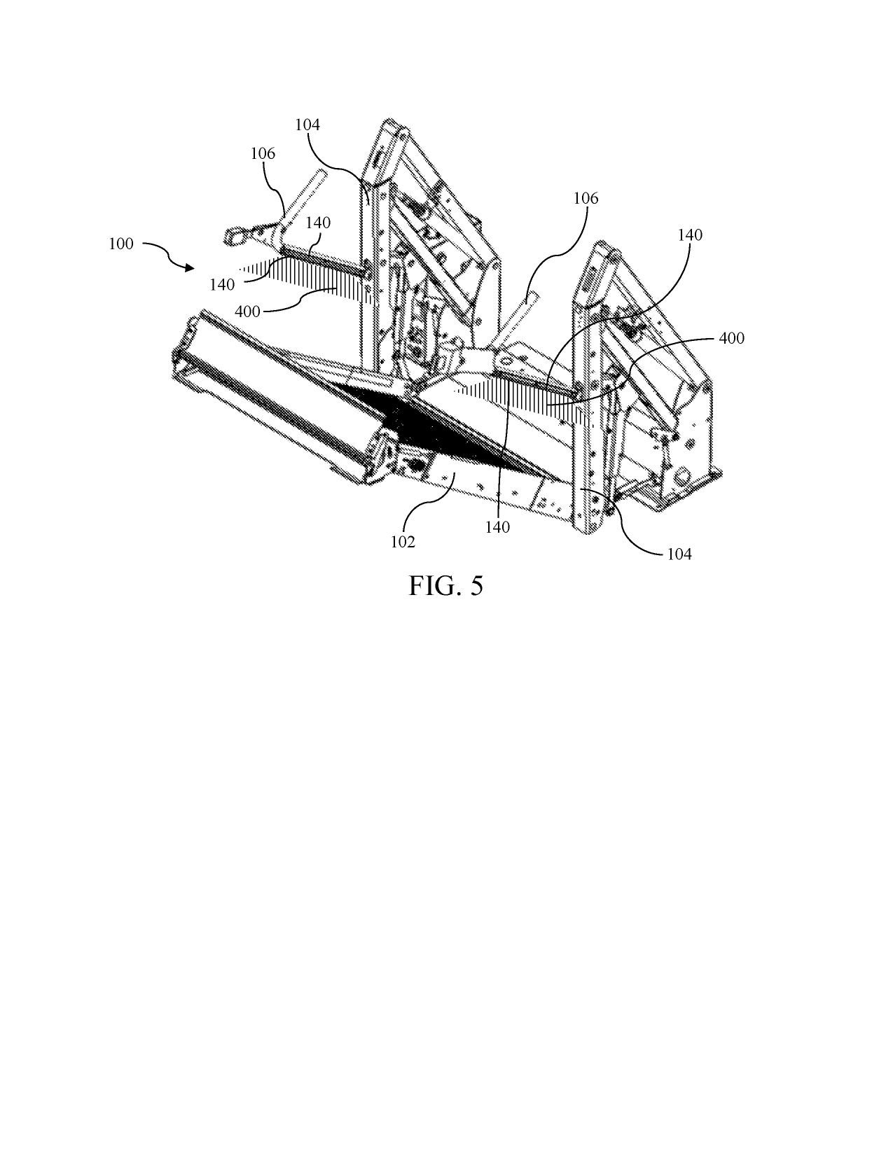

While it is contemplated that other lighting parameters can be adjusted, in FIGS. 4-7, the dynamic lighting controller is configured to modify the luminous flux to reduce the chances of visual impairment for the lift operator. In one embodiment, the dynamic lighting controller may be configured to cause the light strips 140 to emit a low/dim light projection 400 from the light strips 140 when the wheelchair lift 100 is in the stowed position as shown in FIG. 4 and between the stowed position and deployed position as shown in FIG. 5, and a high/bright light projection 600 when the wheelchair lift 100 is in the deployed position as shown in FIGS. 6-7. In some embodiments, the light strips 140 may be activated when the wheelchair lift 100 is powered on and deactivated when the wheelchair lift 100 is powered off.

In other embodiments, during deployment of the wheelchair lift 100, when the platform 102 reaches a predetermined position, the light strips 140 may adjust from the low/dim light projection 400 to the high/bright light projection 600. In some embodiments, the predetermined position may be the stow position (e.g., FIG. 4) as or shortly before the wheelchair lift 100 begins to move, between the full stow position and the partially deployed position (e.g., FIG. 5) as the wheelchair lift 100, or the deployed, floor-level position (e.g., FIG. 6) or deployed, ground-level position (e.g., FIG. 7) as or shortly after the wheelchair lift 100 stops moving.

In the reverse direction, during stowing of the wheelchair lift 100, when the platform 102 reaches a predetermined position, the light strips 140 may adjust from the high/bright light projection 600 to the low/dim light projection 400. In some embodiments, the predetermined position may be the deployed, ground-level position (e.g., FIG. 7) or the deployed, floor-level position (e.g., FIG. 6) as or shortly before the wheelchair lift 100 begins to move, between the deployed position and the stowed position (e.g., FIG. 5), or the stow position (e.g., FIG. 4) as or shortly after the wheelchair lift stops moving.

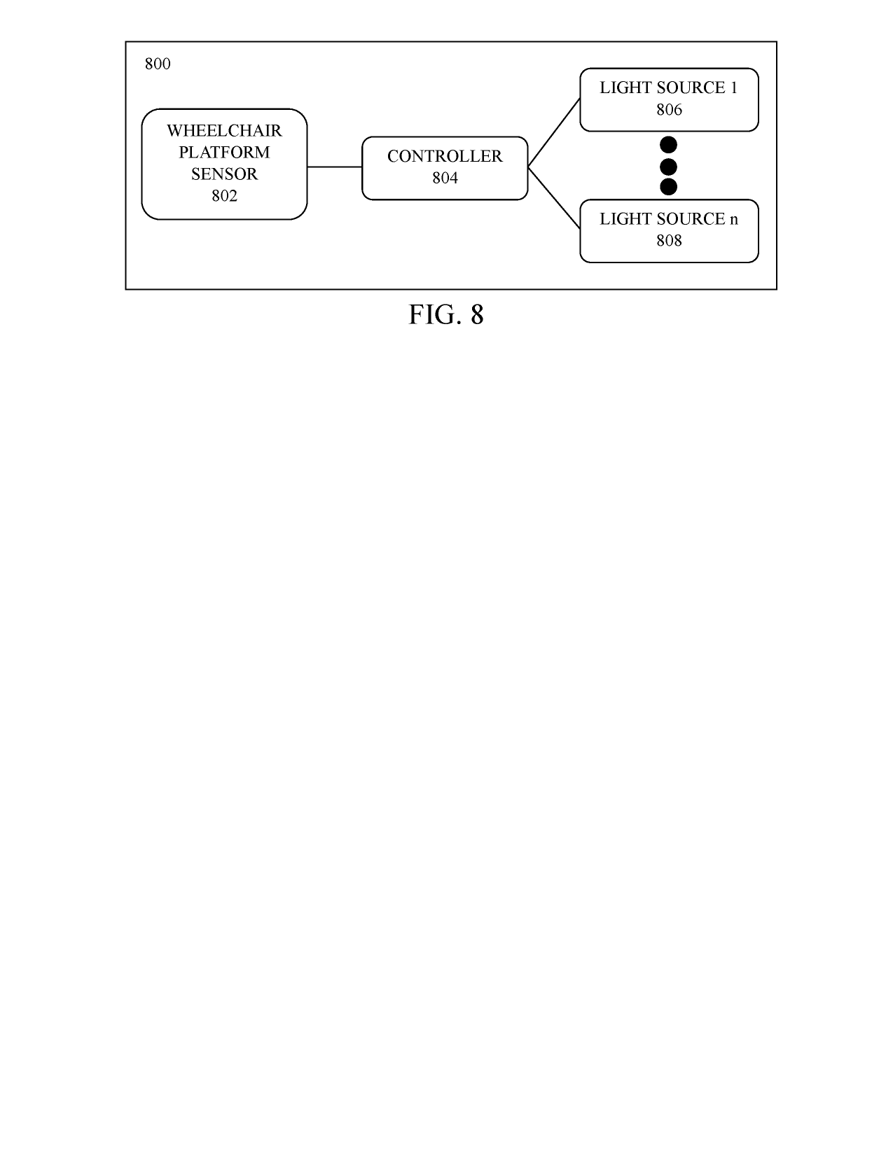

FIG. 8 illustrates a dynamic lighting system 800. The dynamic lighting system 800 may include a wheelchair platform sensor 802 that detects the position (or positions) of the platform 102. The wheelchair platform sensor 802 may be electrically coupled to a controller 804. The controller 804 may then be electrically coupled to at least one light source 806, up to any n number of light sources 808. The controller 804 may be programmed to receive the position of the platform 102 from the wheelchair platform sensor 802 and send a signal to the light source 806, 808 to adjust any lighting parameter, such as luminous flux/brightness, to minimize the chance of vision impairment when the platform 102 is stowed and to ensure that all applicable lighting standards, such as platform illuminance requirements, are met when the platform 102 is deployed and in use.

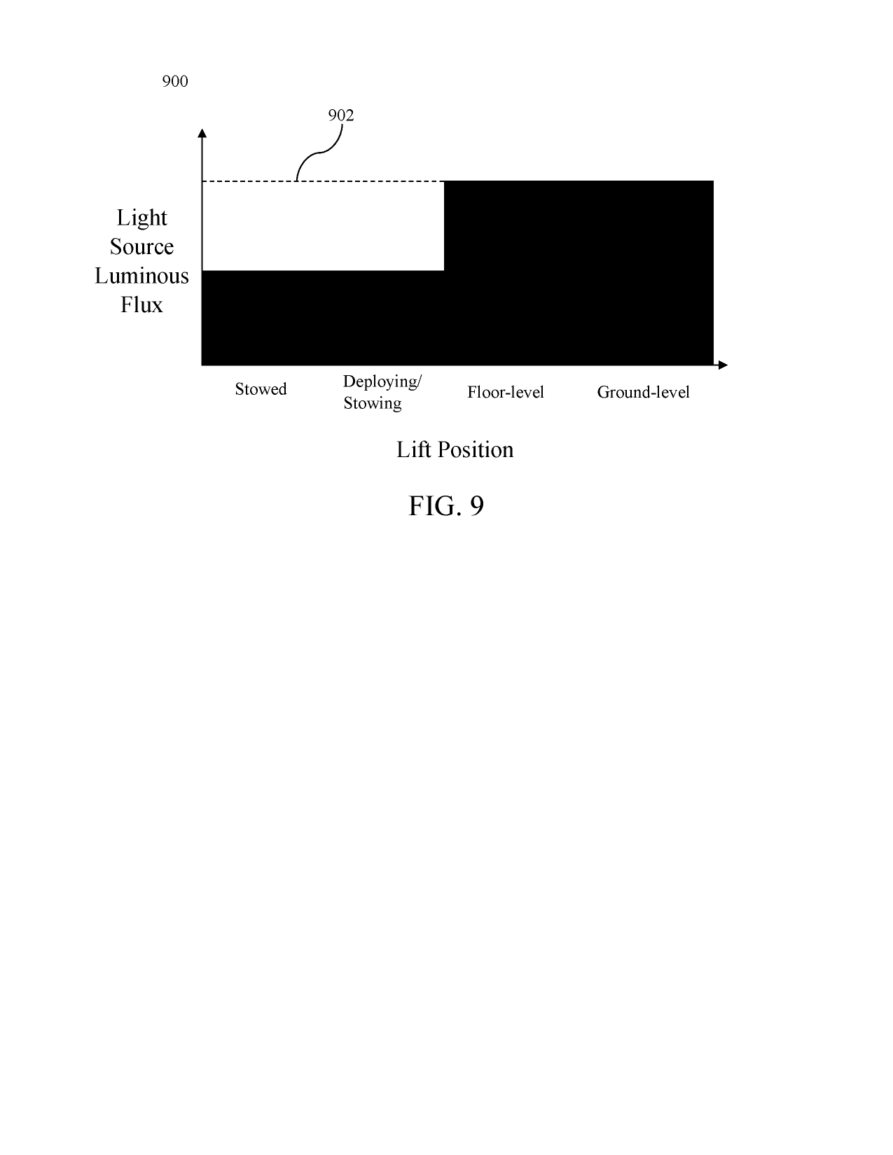

FIG. 9 illustrates a graph in which the luminous flux of the light source 806 may be reduced or increased based on the position of the wheelchair lift platform 102. A luminous flux threshold line 902 may correspond to the relevant governing standard for minimum lift platform illuminance. The controller 804 may be configured to adjust the brightness in a smooth manner (ramp up/down) during wheelchair lift operation rather than a step up/down.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims. For instance, while the present disclosure describes dynamic lighting controls in the context of a specific vehicle access device with a specific configuration and specific types of light sources, it is contemplated that dynamic lighting controls can be implemented with any vehicle access device of any configuration and with any type of light source.

1. A dynamic lighting system for a vehicle access device comprising:
at least one light source configured to illuminate a platform of the vehicle access device;
at least one sensor configured to ascertain a position characteristic of the platform of the vehicle access device;
a controller electrically coupled to the at least one light source and the at least one sensor, wherein the controller is configured to adjust at least one lighting parameter of the light source based on the position characteristic.

2. The dynamic lighting system of claim 1, wherein the controller is configured to receive a signal from the at least one sensor when the position characteristic of the platform reaches a predetermined threshold.

3. The dynamic lighting system of claim 2, wherein the controller is configured to send a signal to the at least one light source to adjust a light output setting when the controller receives the signal from the at least one sensor.

4. The dynamic lighting system of claim 3, wherein the vehicle access device is moveable between a stowed position and a deployed position, wherein the predetermined threshold is a position between the stowed and deployed positions.

5. The dynamic lighting system of claim 4, wherein the at least one lighting parameter adjusted by the controller is a luminous flux of the at least one light source.

6. The dynamic lighting system of claim 5 wherein upon movement of the vehicle access device from the stowed position to the deployed position, the controller increases the luminous flux output of the at least one light source.

7. The dynamic lighting system of claim 6 wherein upon movement of the vehicle access device from the deployed position to the stowed position, the controller decreases the luminous flux output of the at least one light source.

8. The dynamic lighting system of claim 7, wherein the adjustment of the luminous flux is an instantaneous change.

9. The dynamic lighting system of claim 7, wherein the adjustment of the luminous flux is a gradual change over a programmed period of time.

10. The dynamic lighting system of claim 4, wherein the at least one lighting parameter adjusted by the controller is a directional change of the at least one light source.

11. The dynamic lighting system of claim 10, wherein the at least one light source is pointed in a direction towards the platform in the deployed position.

12. The dynamic lighting system of claim 11, wherein the at least one light source is pointed in a different direction in the stowed position.

13. The dynamic lighting system of claim 12 wherein upon movement of the vehicle access device from the stowed position to the deployed position, the controller changes the directional output of the at least one light source to be pointed towards the platform.

14. The dynamic lighting system of claim 12, wherein upon movement of the vehicle access device from the deployed position to the stowed position, the controller changes the directional output of the at least one light source to be pointed in the different direction.

15. The dynamic lighting system of claim 4, wherein the vehicle access device is a wheelchair lift.

16. The dynamic lighting system of claim 4, wherein the at least one sensor includes a partial fold sensor configured to ascertain when the platform reaches a predetermined angle.

17. The dynamic lighting system of claim 4, wherein the at least one sensor includes a platform elevation sensor configured to ascertain when the platform reaches a predetermined height.

18. The dynamic lighting system of claim 4, wherein the at least one sensor includes a timing device configured to ascertain a duration of an operator pressing a controller.

19. A passenger vehicle modified to accommodate physically limited passengers, the passenger vehicle comprising a vehicle access device, the vehicle access device having:
at least one light source configured to illuminate a platform of the vehicle access device;
at least one sensor configured to ascertain a position characteristic of the platform of the wheelchair lift;
a controller electrically coupled to the at least one light source and the at least one sensor, wherein the controller is configured to adjust at least one lighting parameter of the light source based on the position characteristic.

20. A method of adjusting one or more light sources for a vehicle access device comprising:
ascertaining at least one characteristic representative of a position of a platform of the vehicle access device;
adjusting a lighting parameter of the one or more light sources when the at least one characteristic indicates that the position of the platform has reached a predetermined position threshold.
